(19) United States
(12) Patent Application Publication
(10) Pub. No.: US 2012/0181381 A1
(43) Pub. Date: Jul. 19, 2012

(54) SELF-RIGHTING AEROSTAT AND RELATIVE TAKEOFF AND RECOVERY SYSTEM

(75) Inventors: Piercarlo Vercesi, Canneto Pavese (PV) (IT); Matteo Vazzola, Asti (AT) (IT); Alberto Favro, Mathi (TO) (IT)

(73) Assignee: NOCE S.R.L., Canneto Pavese (PV) (IT)

(21) Appl. No.: 13/387,685

(22) PCT Filed: Jul. 28, 2010
(86) PCT No.: PCT/IB10/01916

§ 371 Date: Apr. 5, 2012

(30) Foreign Application Priority Data
Jul. 28, 2009 (IT) MI2009A001340

(51) Int. Cl. B64B 1/70; B64B 1/66

(52) U.S. Cl. 244/96

(57) ABSTRACT

A self-righting aerostat (10) is described comprising at least one blimp-shaped body (12), supported by gas and in which a bow and a stern are defined, a plurality of tailplanes (13) having a stabilizing function, a self-righting system provided with a ballast, consisting of liquid, able to be moved through a pump (22) from the bow to the stern of the blimp-shaped body (12) and vice-versa, a system for controlling the trim based upon the actuation of mobile parts (27) of the tailplanes (13) and on propellers driven by motors (28; 29), and a takeoff and recovery system (34) comprising a winch device (35) on which a cable is wound (19) to anchor the aerostat to the ground (10). The self-righting aerostat (10) also comprises, inside the blimp-shaped body (12), at least one connection cable (25) between the stern and the bow of the blimp-shaped body (12) itself, in order to improve the rigidity of shape of the aerostat (10) when it is pulled about in strong winds, which tend to stretch the relative blimp-shaped body (12).

The present invention refers to an improved self-righting aerostat, as well as to a takeoff and recovery system of such a self-righting aerostat. In particular, the invention refers to a self-righting aerostat having a support function to maintain detection and/or communication equipment, sensors, videocameras or antennas at a predefined height. In the field of static detection and of communication through flying means, generally aircrafts with a rotary wing (helicopters), fixed wing aircrafts or, in some cases, other aerostatic supported airborne means, equipped with the equipment necessary for the operations to be carried out, are used.

The drawbacks of using a motor means are clearly related to the generation of noise, to the emission of pollutants into the atmosphere and to the generation of considerable air flows. In addition, in the case of aircrafts with fixed wings, it is necessary to keep them moving in order to keep them airborne, whereas both in the case of a rotary wing and of fixed wings it is necessary to continuously supply them with fuel.

In some cases airships and aerostats are used, but these means are too sensitive to meteorological conditions and can only rarely be used.

Examples of aerostats according to the prior art currently applied are those of the spherical type, or of various shapes intermediate between the sphere and the more or less elongated blimp-shaped body, with or without tailplanes. The aerostat is normally fixedly connected to the wing underside by a funicular that connects it to the take-off cable. In other words, the aerostat is maintained at the same altitude through a takeoff and a recovery system, comprising an anchoring cable fixed to a suitable connection element in the lower part of the blimp-shaped body and in turn fixedly connected to the ground, where there is a winch type winding/unwinding device.

The longitudinal balancing of the aerostat in some cases is obtained on the ground, before the aerostat itself takes off, arranging suitable ballast weights in suitable positions. The payload, in this case consisting of the detection equipment, can be supplied with power through on-board batteries or through an electric cable that reaches the ground and that is integrated in the anchoring cable of the aerostat. Whether the first or second of these solutions is used, of course depends on the energy necessary for the operation of the equipment and whether or not it is necessary to communicate through a cable to the ground in real time what the equipment is detecting.

The forces acting upon the aerostat are the resistance D, the aerostatic thrust B, the weight force W and the constraint force F obtained by the anchoring cable. Especially in the case of a blimp-shaped body aerostat, each of these forces has a point of application that is normally different from the others and undergoes variations in intensity and direction due to meteorological conditions, to the wind direction and intensity, to air pressure and temperature.

In order to avoid the drawbacks affecting trim and position in aerostats, self-righting aerostats have been made equipped with particular provisions that make it possible to control the trim, like for example fluid mass shifting hydraulic systems. Unfortunately, in these cases it has been verified that the time constants for the response in reaction are too long and, in many cases, not efficient.

Moreover, in some rare cases, in known types of aerostats, the cable for anchoring to the ground also usually carries out the function of electric cable for supplying power to all the services present on the aerostat itself. The structural part of the cable, in the most advanced systems made in plaits of polymeric material, normally forms the outer shell of the cable itself, in a manner such as to enclose the electric cables inside it. Consequently, for example, in the case of lightning, the structural part of the anchoring cable is the part that is damaged or destroyed by the melting, or worse, by the evaporation of the inner conductors hit by lightning, since it is in the outer part of the cable itself, with the risk or almost certainty of losing the aerostat due to the breaking thereof.

In addition, current winch type take-off and recovery systems, due to their particular configuration, can cause excessive stress, due to the radius of curvature to which the cable is subjected when it is wound around itself, therefore requiring an oversizing of the sub-systems of the cable itself (structural part and conductor part), as well as an increase of the risk of malfunctioning. What has been said, for aerostats supplied with power from the base, makes it necessary to use take-off cables having a considerable weight and therefore to substantially reduce the payload.

The general purpose of the present invention is therefore that of making an improved self-righting aerostat and a relative takeoff and recovery system that is able to avoid the aforementioned drawbacks of the prior art in an extremely simple, cost-effective and particularly functional manner.

In particular, one purpose of the present invention is that of making an improved self-righting aerostat that allows a fast response time to control the trim in all possible situations of use.

A further purpose of the invention is that of making an improved self-righting aerostat in which it is possible to considerably reduce the weight of the take-off cable, also improving the performances in the case of lightning so as to allow the possibility of recovering the aerostat itself after such a situation.

Yet another purpose of the invention is that of making an improved self-righting aerostat with takeoff and recovery system that makes it possible to substantially reduce the mechanical stress that the take-off cable undergoes, allowing it to be lightened and, if desired, allowing the take-off and recovery steps to be managed automatically.

These purposes according to the present invention are achieved, by making an improved self-righting aerostat as outlined in claim 1.

Further characteristics of the invention are highlighted in the dependent claims, which are an integral and integrating part of the present description.

The characteristics and the advantages of an improved self-righting aerostat and of the relative take-off system according to the present invention shall become clearer from the following description, given as an example and not for limiting purposes, with reference to the attached schematic drawings in which:

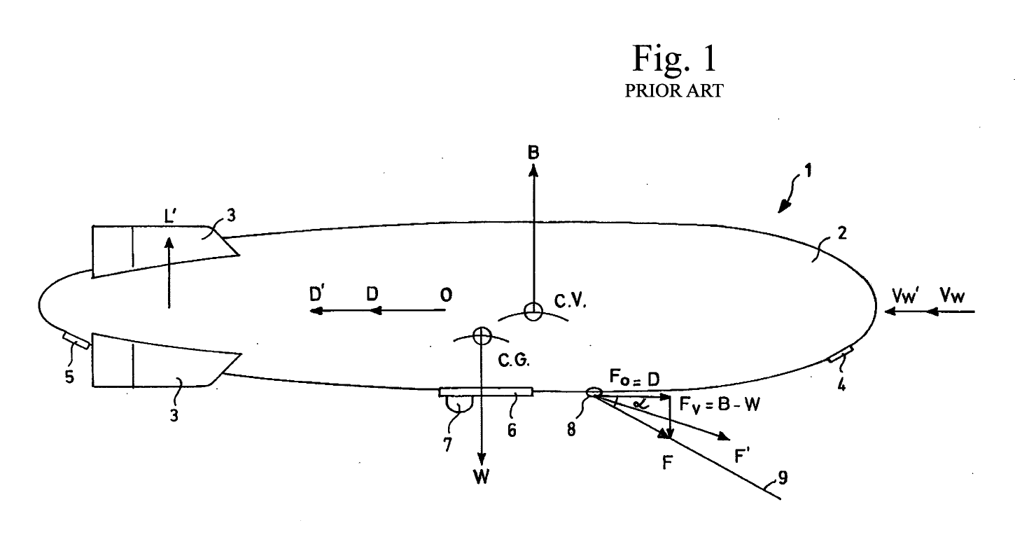

FIG. 1 is a schematic side view of an aerostat of the conventional type made according to the prior art;

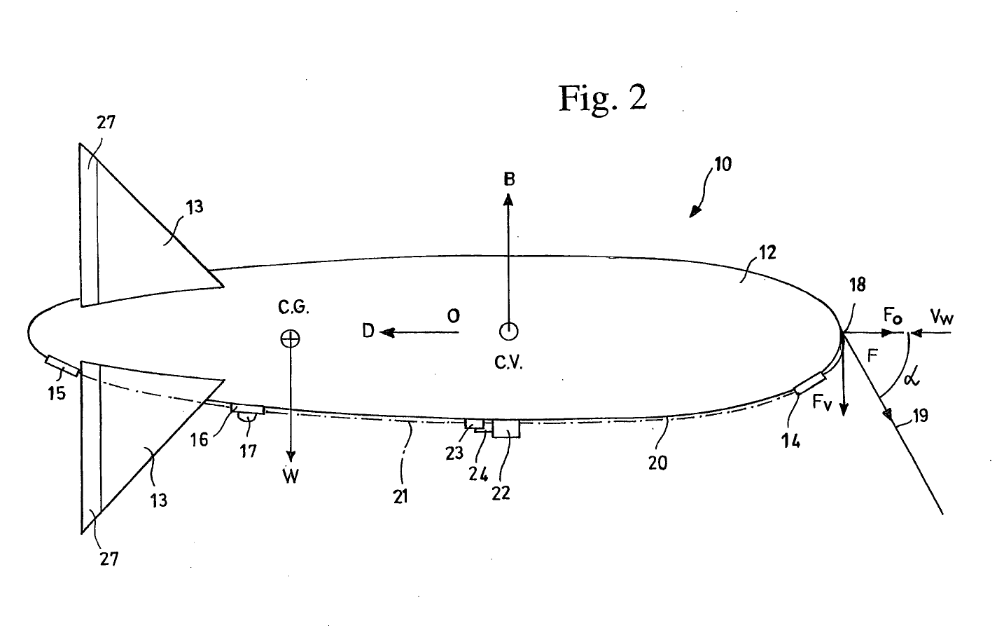

FIG. 2 is a schematic side view of an aerostat of the self-righting type, in which the forces acting upon it are highlighted;

Figures from 3 to 5 are perspective schematic views illustrating some embodiments of an improved self-righting aerostat according to the present invention;

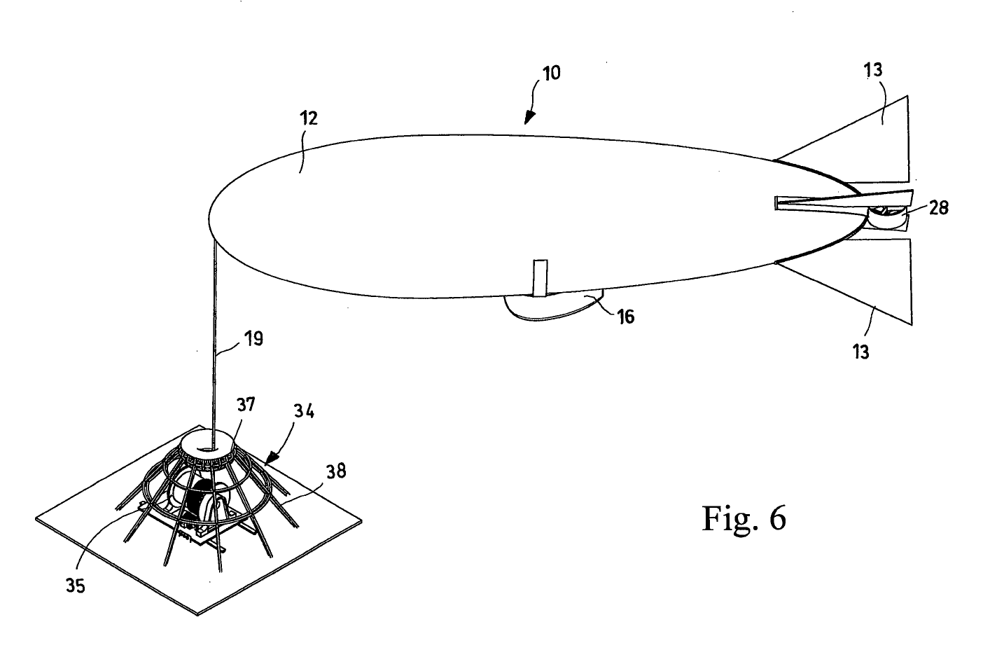

FIG. 6 is a perspective schematic view that illustrates an improved self-righting aerostat according to the present invention provided with the relative takeoff and recovery system;

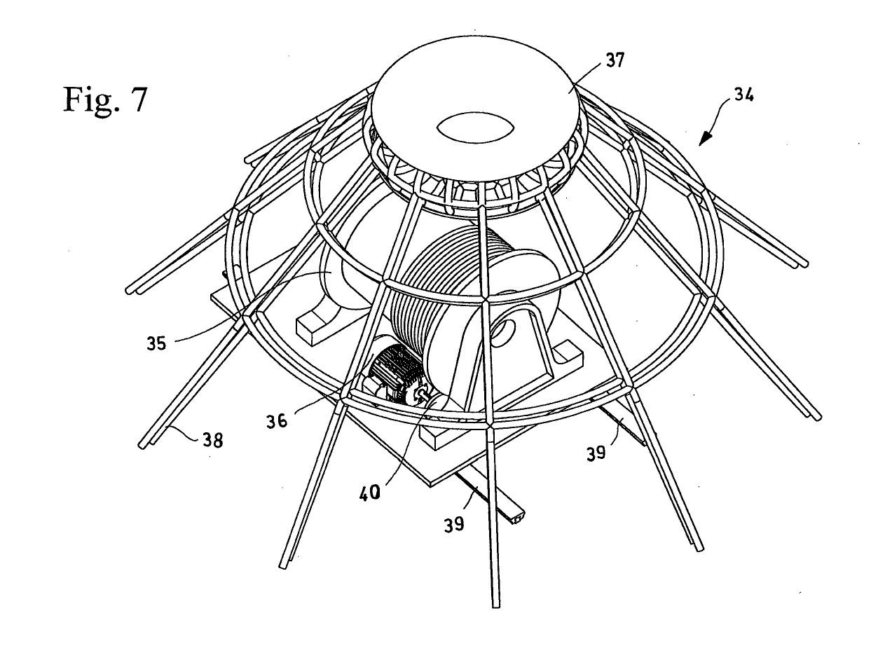

FIG. 7 is a perspective schematic view illustrating a takeoff and recovery system for an improved self-righting aerostat according to the present invention;

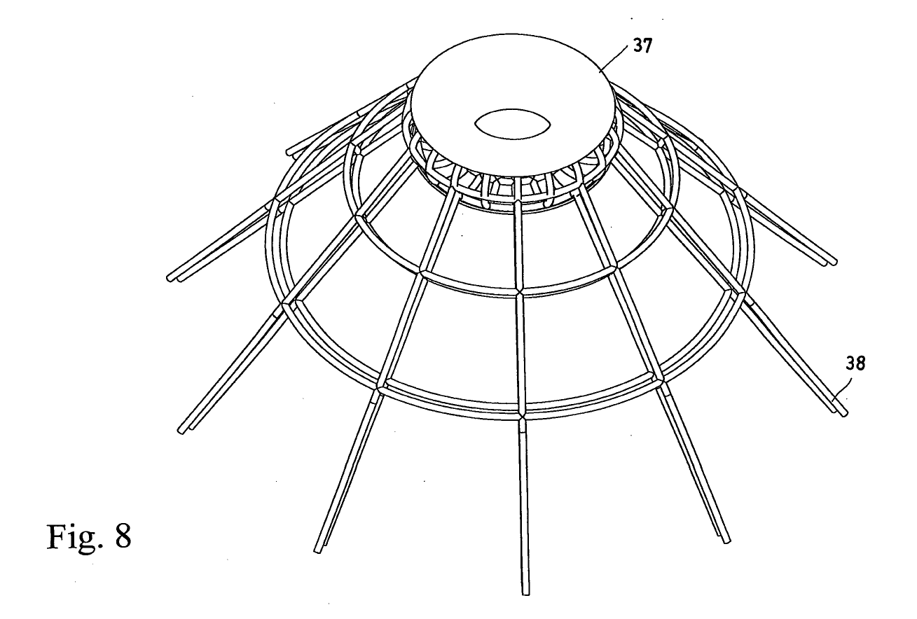

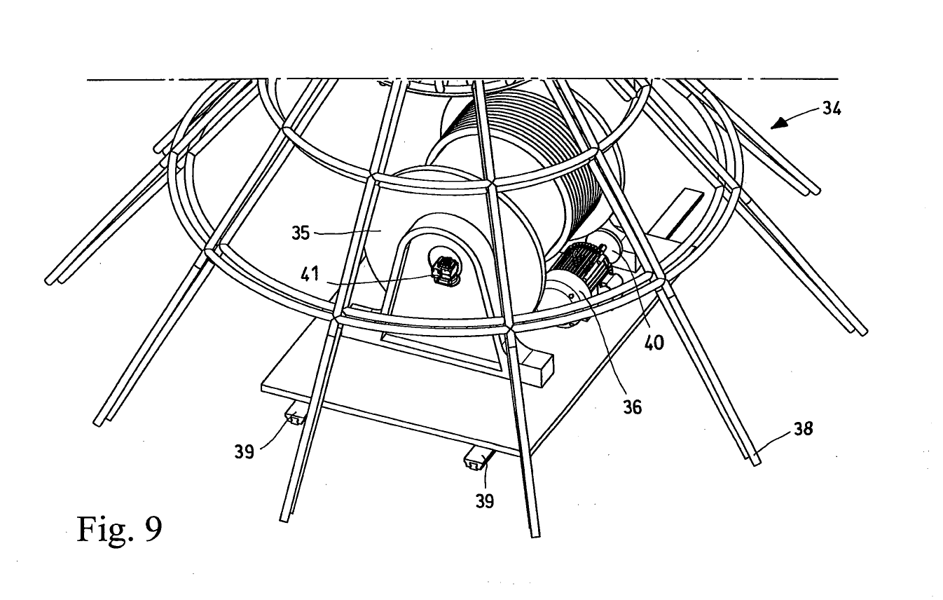

FIGS. 8 and 9 are perspective schematic views illustrating the details of the takeoff and recovery system of FIG. 7;

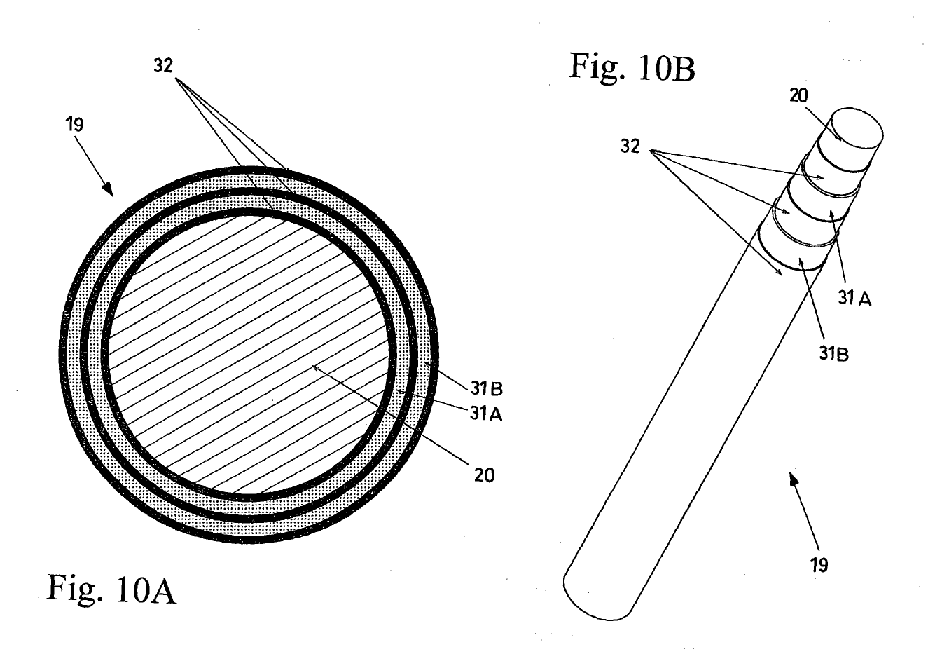

FIGS. 10A and 10B, respectively a cross-section view and a partially sectioned perspective view, show a first embodiment of an anchoring cable of an improved self-righting aerostat according to the present invention;

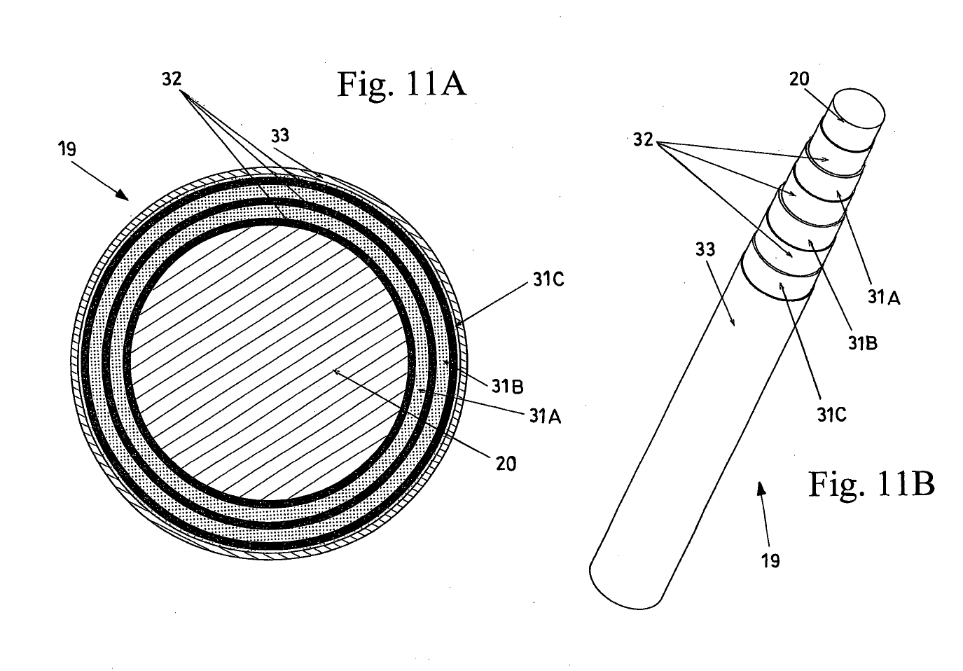

FIGS. 11A and 11B, respectively a cross-section and a partially sectioned perspective view, show a second embodiment of an anchoring cable of an improved self-righting aerostat according to the present invention; and

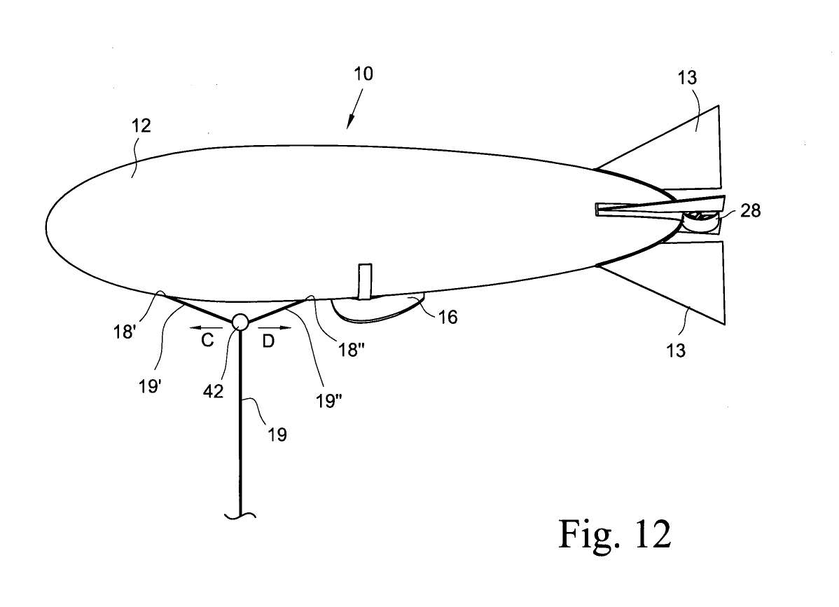

FIG. 12 shows a stabilizing system for the point which is fastened to the ground of an improved self-righting aerostat according to the present invention.

With reference to FIG. 2, a self-righting aerostat is shown, wholly indicated with reference numeral 10, which can be piloted or remotely piloted from the ground and that can have the function of a support platform for equipment for photographs and aerial recordings, environmental monitoring and low altitude detection, radio repeaters and support for antennas in general, or yet other purposes.

The aerostat 10 is of the nonrigid type, in other words without a supporting structure and with the required shape substantially ensured by the light overpressure of the gas contained inside it. Preferably, the aerostat 10 foresees lifting by means of helium.

The aerostat 10 comprises at least one blimp-shaped body 12 and a plurality of tailplanes or empennages 13 having a stabilizing function.

The aerostat 10 is also equipped with a self-righting system provided with a ballast, made up of a liquid, able to be moved through a pump 22 from the bow to the stern and vice-versa through a duct 21 between a bow container or sack 14 and a stern container or sack 15, fixed to the bow and to the stern of the blimp-shaped body 12, respectively. Such a self-righting system can be completely automated and is slaved, through a line 24, to an inertial platform 23 that detects the variation in longitudinal trim angle of the aerostat 10 and, through the line 24, controls the pump 22 so as to allow the aerostat 10 itself to be kept horizontal as both the wind speed V_{w} and the aerostatic thrust B vary, the latter being variable as the atmospheric pressure and temperature vary.

FIG. 2 shows the forces acting upon the aerostat 10 and That are balanced by the aforementioned self-righting system. Such forces, in a per se known manner, are represented by:
the resistance D, applied at the point O of the aerostat 10;
the aerostatic thrust B, applied at the centre of volume C.V. of the aerostat 10;
the weight force W, constant and applied to the centre of gravity C.G. of the aerostat 10; and
the constraint force F, obtained by the cable 19 to anchor the aerostat to the ground 10, which can be subdivided into a horizontal component Fₒ, equal to the value of D and with which the direction of F forms an angle α, and a vertical component Fᵥ, equal to the difference between the aerostatic thrust B and the weight force W.

The payload 17, consisting of the aforementioned equipment and located in a gondola 16, arranged below the blimp-shaped body 12, can be supplied with power through batteries 30 arranged in the gondola 16 itself, or through an electric cable that reaches the ground and that is associated with the anchoring cable 19, as shall be made clearer in the rest of the description.

In order to further balance the aerostat 10, the connection element 18 of the cable 19 for anchoring to the ground can be arranged exactly on the bow end of the aerostat 10 itself. In such a way, the aerodynamic resistance D does not generate any pitching moment with respect to the connection element 18 of the cable 19 to the aerostat 10. Moreover, there is no variation of longitudinal inclination of the aerostat 10 due to the variation of the wind speed V_{w}.

Alternatively, the cable 19 for anchoring to the ground can be provided with a stabilizing system based upon the shifting and upon the adjustment of the relative connection element 18. Two distinct connecting elements 18′ and 18″ can indeed be foreseen on the blimp-shaped body 12 of the aerostat 10, to which two separate ends 19′ and 19″ of the cable 19 for anchoring to the ground are connected. A geared motor group 42, provided with a winch and controlled by the inertial platform 23, is able to wind the first end 19′ of the cable 19 for anchoring to the ground in the direction of the first connection element 18′ (direction C of FIG. 12), simultaneously unwinding the second end 19″ of such a cable 19 for anchoring to the ground. Vice-versa, the geared motor group 42 is also able to wind the second end 19″ of the cable 19 for anchoring to the ground in the direction of the second connection element 18″ (direction D of FIG. 12, opposite to the direction C), simultaneously unwinding the first end 19′ of such a cable 19 for anchoring to the ground.

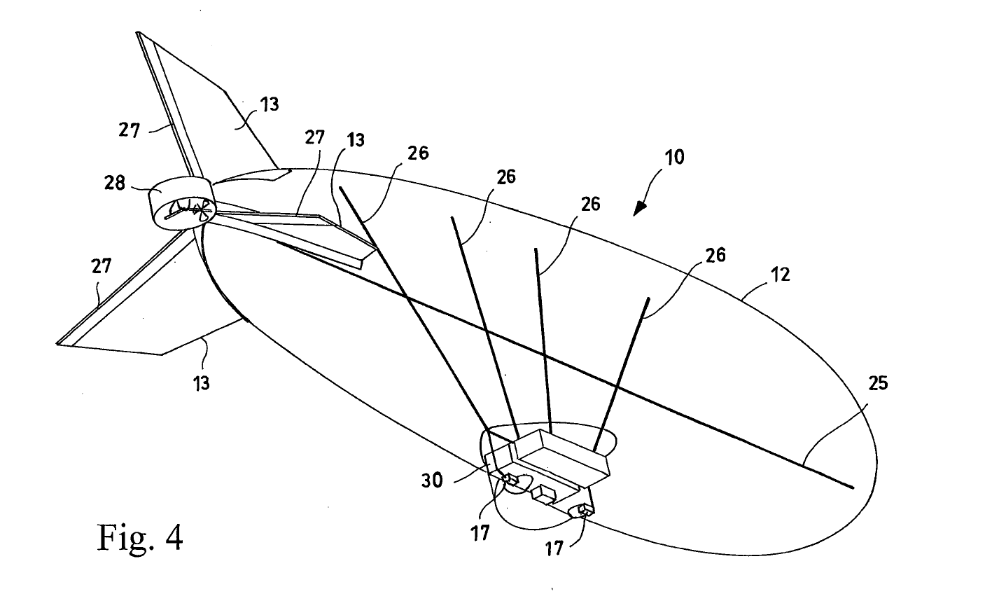

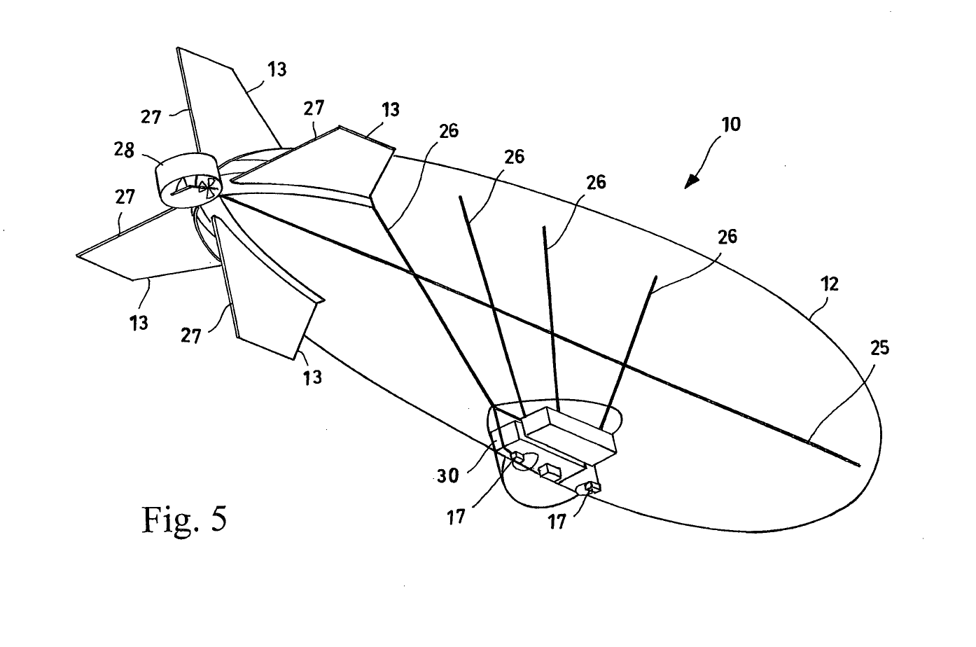

The aerostat 10, inside the blimp-shaped body 12, is provided with at least one connection cable 25 between the stern and the bow of the aerostat 10 itself (FIGS. 4 and 5), so as to improve its rigidity of shape when it is pulled about in strong winds, which tend to elongate the blimp-shaped body 12. The connection cable 25 is provided with means (not shown) for recovering the geometric clearances deriving from the atmospheric temperature or from other factors not linked to the wind.

Again inside the blimp-shaped body 12 of the aerostat 10, there can also be one or more tie-rods 26, preferably oriented transverse with respect to the direction of the connection cable 25, which are used in order to obtain a better distribution of the loads weighing down on the blimp-shaped body 12 itself.

Advantageously, the tailplanes 13 of the aerostat 10 can have at least one mobile surface portion 27, slaved to a controlling system and moved automatically. The function of the mobile surfaces 27 is to counteract the small longitudinal and directional oscillations of the aerostat 10 due to atmospheric turbulence, as well as to allow a fast response time to control the trim when the aerostat 10 itself is located in a flow of air.

The tailplanes 13 of the aerostat 10 can be applied to the stern portion of the blimp-shaped body 12 in a variable number and according to different geometrical positions. For example, three tailplanes 13 can be foreseen, said tailplanes being equally spaced apart from one another, in a Y configuration (FIG. 4), or four tailplanes 13, again equally spaced apart from one another, in an X configuration (FIG. 5).

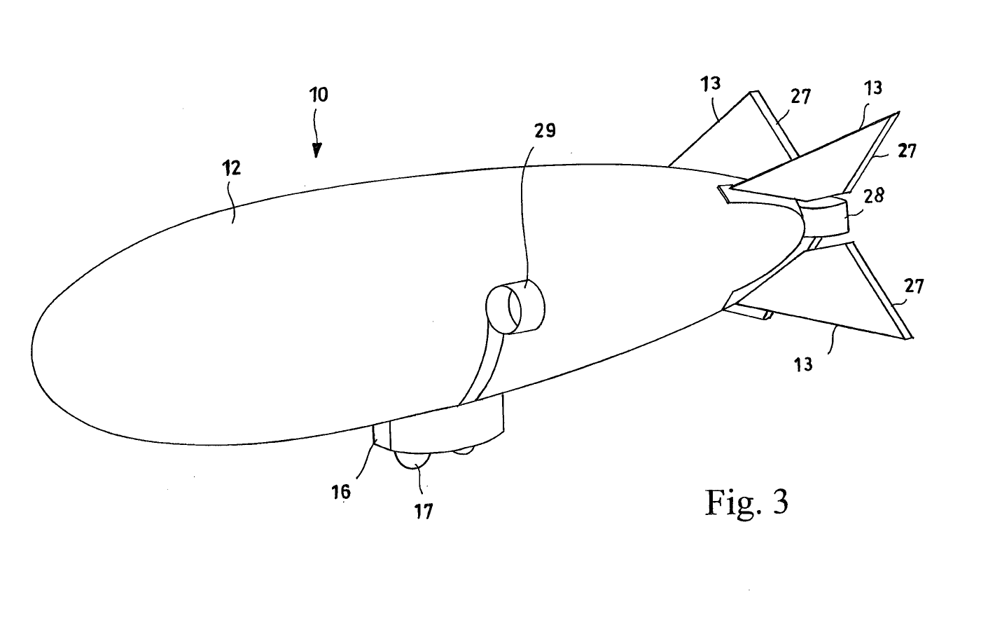

One or more electric motors 28, 29 can also be installed on the aerostat 10, said motors being provided with propellers to counteract, with their thrust, aerodynamic resistance and thus maintain the exact geographical and spatial position of the aerostat 10 itself. For example, one or more electric motors 28 having vertical axes positioned at the tail or stern of the blimp-shaped body 12 of the aerostat 10 can be foreseen, in order to maintain a fast response time in controlling the trim when the tailplanes 13 and the relative mobile surfaces 27, when present, are not sufficiently effective, like for example when the flow of air is too slow or non-existent. Alternatively or in addition, one or more electric motors 29 having horizontal axes positioned at the sides of the blimp-shaped body 12 (FIG. 3) can be foreseen, to counteract all, or at least part of the thrust of the wind and thus extend the extremes of the flight envelope diagram of the aerostat 10.

In the case in which there are electric motors 28, 29 on-hoard of the aerostat 10, the fluid mass shifting self-righting system can be used for the secondary stabilization of the trim, in other words activating it once the stabilization of the desired trim has been obtained with the action of the motors 28, 29.

The entire aerostat 10, just like the relative motors 28, 29 and the payload 17, can be supplied with power through batteries 30 arranged in the gondola 16 below the blimp-shaped body 12, or through the electric cable that reaches the ground and that is associated with the anchoring cable 19. For such a purpose, possible different sources of electric energy that are necessary for the motors 28, 29 can be foreseen, from simple rechargeable batteries (for example, lithium, NiCd or NiMH batteries), to auxiliary generators mounted on-board of the aerostat 10, to fuel cells and yet more.

With reference to FIGS. 10A and 10B, a first embodiment of the cable 19 to anchor the aerostat to the ground 10 is shown. The cable 19 comprises a traction-resistant central core 20, preferably manufactured with a plait of polymeric material with high traction resistance.

Around the central core 20 of the cable 19, in a sleeve-type configuration, two layers of concentric conductive plaits 31A and 31B are fitted, preferably manufactured in copper, said plaits forming the electric cable for supplying power to all the services present on-board of the aerostat 10. Between the two concentric conductive layers 31A and 31B, just like between the innermost conductive layer 31A and the central core 20 and around the most outer conductive layer 31B, sheaths 32 of suitable insulating material are applied, suitably sized for the power supply voltage.

The most outer conductive layer 31C, on the other hand, is coated with a specific sheath 33 manufactured from a low-friction insulating material, which is resistant to atmospheric agents and solar radiation.

With reference, on the other hand, to FIGS. 11A and 11B, a second embodiment of the cable 19 to anchor the aerostat to the ground 10 is shown. Even in this case the cable 19 comprises a central core 20 in plait of polymeric material with high traction resistance.

Around the central core 20 of the cable 19 on the other hand, in a sleeve-type configuration, three layers of concentric conductive plaits 31A, 31B and 31C are fitted, preferably manufactured in copper. More in detail, the two innermost conductive layers 31A and 31B operate to transmit the electrical power, whereas the most outer conductive layer 31C operates to protect and to ground the cable 19. Analogously to the previous embodiment of the cable 19, between the three concentric conductive layers 31A, 31B and 31C, just like between the innermost conductive layer 31A and the central core 20, sheaths 32 of suitable insulating material are applied, suitably sized for the power supply voltage. The most outer conductive layer 31C is, on the other hand, coated with a specific sheath 33 manufactured from a low-friction insulating material, which is resistant to atmospheric agents and to solar radiation.

Such a cable 19 to anchor the aerostat to the ground 10 is particularly resistant to lightning, since the traction-resistant central core 20, with a structural function, is protected from melting/evaporation of the hit conductor 31. The risk of losing the aerostat 10 due to detachment from the ground is thus minimized. Moreover, this solution also substantially reduces the overall weight of the cable 19, reducing the fillers and the volume of the cable 19 itself, with respect to the known types of solutions, with equal electromechanical characteristics.

With reference now to FIG. 7, a takeoff and recovery system 34 of an aerostat 10 according to the invention is shown. The takeoff and recovery system 34, in a per se known manner, comprises a winch device 35, actuated by an electric motor 36 and positioned on the ground. The cable 19 winds or unwinds around the drum of the winch device 35 so as to obtain the arrangement of the aerostat 10 at the desired height.

According to one preferred aspect of the present invention, at the takeoff and recovery system 34, more precisely at the drum of the winch device 35, a toroidal entry ring 37 for the cable 19 is applied. The toroidal entry ring 37, which can rest on the ground through a suitable support structure 38, is made with a sufficiently high radius of curvature to ensure a low level of stress on the cable 19, at the same time optimizing its winding in all possible directions.

The winch device 35 is in turn mounted on one or more horizontal guides 39 that allow it to slide in the longitudinal direction. In such a way, during the winding and unwinding operations of the cable 19, the winch device 35 moves along its own axis with an irreversible motion transmission system to maintain the cable 19 itself always in a central position, in other words at the toroidal entry ring 37 above. In such a way, portions of the cable 19 avoid overlapping the drum of the winch device 35 during winding operations, contributing to limit the strain weighing down on the cable 19 itself.

The system for shifting the winch device 35, both around its own axis and along the horizontal guides 39, is made by the electric motor 36 through an electromechanical transmission group 40, which synchronizes the rotation of the drum with its longitudinal sliding to avoid crossing over the cable 19 during the operation of the takeoff and recovery system 34.

Preferably, the electric motor 36 for rotating the drum of the winch device 35 is arranged on the outer radius of the drum itself, so as to have the arms favoring the motor and not the cable 19. Finally, on the winch device 35, in axis with respect to the relative drum, a system of sliding contact 41 is mounted so as to avoid undesired winding of the cable 19.

It has thus been seen that the improved self-righting aerostat according to the present invention achieves the purposes previously highlighted.

The improved self-righting aerostat of the present invention thus conceived can in any case undergo numerous modifications and variants, all covered by the same inventive concept; moreover, all the details can be replaced by technically equivalent elements. Therefore, for example, the tail motor, instead of having vertical axis like in the attached figures, can have a horizontal axis, a double axis (both vertical and horizontal) or a variable axis (so called “tilting rotor”). Similarly, the tailplanes can have geometrical positions that are different from those illustrated (X, Y or cross) and be in a variable number.

The scope of protection of the invention is thus defined by the attached claims.

1. Self-righting aerostat (10) comprising:
at least one blimp-shaped body (12) supported by gas and in which a bow and a stern are defined;
a plurality of tailplanes (13) having a stabilizing function;
a self-righting system provided with a ballast, consisting of liquid, able to be moved through a pump (22) from the bow to the stern of said blimp-shaped body (12) and vice-versa; and
a takeoff and recovery system (34) comprising a winch device (35) on which a cable (19) is wound to anchor the aerostat (10) to the ground, said liquid of said self-righting system being able to be moved through a duct (21) connecting said pump (22) to a bow container (14) and a stern container (15), suitably fixed at the bow and stern of said blimp-shaped body (12), respectively, characterized in that said self-righting system is completely automated and is slaved, through a line (24), to an inertial platform (23) that detects the variation in longitudinal trim angle of the aerostat (10) and, through said line (24), controls said pump (22) so as to allow the aerostat (10) to be kept horizontal as both the wind speed (V_{w}), and the aerostatic thrust (B) vary, the latter being variable as the atmospheric pressure and temperature vary.

2. Self-righting aerostat (10) according to claim 1, characterized in that it comprises, inside said blimp-shaped body (12), at least one connection cable (25) between the stern and the bow of said blimp-shaped body (12), in order to improve the rigidity of shape of the aerostat (10) when it is pulled about in strong winds, which tend to stretch out said blimp-shaped body (12).

3. Self-righting aerostat (10) according to claim 2, characterized in that said connection cable (25) is provided with means for recovering the geometric clearances deriving from the atmospheric temperature or from other factors not linked to the wind.

4. Self-righting aerostat (10) according to claim 1, characterized in that said tailplanes (13) have at least one mobile surface portion (27), slaved to more or less complex acceleration sensors and moved automatically, the function of which is to counteract the small longitudinal and. directional oscillations of the aerostat (10) due to atmospheric turbulence, as well as to allow a fast response time to control the trim when the aerostat (10) is located in a flow of air.

5. Self-righting aerostat (10) according to claim 4, characterized in that it comprises one or more electric motors (28; 29) provided with propellers to counteract, with their thrust, aerodynamic resistance and thus maintain the exact geographical and spatial position of the aerostat (10).

6. Self-righting aerostat (10) according to claim 5, characterized in that said one or more electric motors (28) have a vertical axis and are positioned at the stern of said blimp-shaped body (12), in order to maintain a fast response time in controlling the trim when said tailplanes (13) and the relative mobile surfaces (27) are not sufficiently-effective, like for example when the flow of air is too slow or non-existent.

7. Self-righting aerostat (10) according to claim 5, characterized in that said one or more electric motors (29) have a horizontal axis and are positioned at the sides of said blimp-shaped body (12), to counteract all or at least part of the thrust of the wind and thus extend the extremes of the flight envelope diagram of the aerostat (10).

8. Self-righting aerostat (10) according to any claim 1, characterized in that said cable (19) for anchoring to the ground comprises a traction-resistant central core (20), having a structural function, around which two or more layers of concentric conductive plaits (31A; 31B; 31C) are fitted, in a sleeve-type configuration, separated by suitable insulating layers (32), which form the electric cable for supplying power to all the services present on-board the aerostat (10).

9. Self-righting aerostat (10) according to claim 8, characterized in that the most outer conductive layer (31C) is coated with a specific sheath (33) manufactured from a low-friction insulating material, which is resistant to atmospheric agents and solar radiation.

10. Self-righting aerostat (10) according to claim 8, characterized in that said cable (19) for anchoring to the ground is fastened, through at least one connection element (18), exactly on the bow end of the aerostat (10), so that the aerodynamic resistance (D) to which said aerostat (10) is subjected does not cause any pitching moment.

11. Self-righting aerostat (10) according to claim 8, characterized in that said cable (19) for anchoring so the ground is provided with two separate ends (19′, 19″) hooked to two distinct connection elements (18′, 18″) arranged on the blimp-shaped body (12), a geared motor group (42), provided with a winch and controlled by said inertial platform (23), being capable of winding a first (19′) of said two ends of the cable (19) for anchoring to the ground in the direction (C) of a first (18′) of said two connecting elements, simultaneously unwinding the second end (19″), or winding the second (19″) of said two ends of the cable (19) for anchoring to the ground in the direction (D) of the second (18″) of said two connecting elements, simultaneously unwinding the first end (19′).

12. Self-righting aerostat (10) according to claim 1, characterized in that at the drum of said winch device (35) a toroidal entry ring (37) for said cable (19) for anchoring to the ground is applied, said toroidal entry ring (37) being placed on the ground through a suitable support structure (38) and being made with a sufficiently high radius of curvature to ensure a low level of stress for said cable (19) for anchoring to the ground, at the same time optimizing its winding in all possible directions.

13. Self-righting aerostat (10) according to claim 12, characterized in that said winch device (35) is mounted on one or more horizontal guides (39) that allow it to slide in the longitudinal direction, so as to keep said cable (19) for anchoring to the ground always in a central position, in other words at said toroidal entry ring (37), during the relative winding and unwinding operations.

14. Self-righting aerostat (10) according to claim 13, characterized in that the system for moving said winch device (35), both around its own axis and along said horizontal guides (39), is carried out by an electric motor (36) through an electromechanical transmission group (40), which synchronizes the rotation of said winch device (35) with the longitudinal sliding of the same to avoid crossing over of said cable (19) for anchoring to the ground.

15. Self-righting aerostat (10) according to claim 14, characterized in that said electric motor (36) is arranged on the outer radius of the drum of said winch device (35), so as to have the arms favoring the motor and not said cable (19) for anchoring to the ground.

16. Self-righting aerostat (10) according to claim 1, characterized in that a sliding contact system (41) is mounted on said winch device (35), in axis with respect to the relative drum, so as to avoid undesired winding of said cable (19) for anchoring to the ground.
